(19) United States
(12) Patent Application Publication
(10) Pub. No.: US 2012/0004068 A1
(43) Pub. Date: Jan. 5, 2012

(54) GEAR TRAIN OF AUTOMATIC TRANSMISSION FOR VEHICLES

(75) Inventors: Jongsool Park, Hwaseong-si (KR); Hyukjun Lee, Yongin-si (KR)

(73) Assignee: Hyundai Motor Company, Seoul (KR)

(21) Appl. No.: 12/958,075

(22) Filed: Dec. 1, 2010

(30) Foreign Application Priority Data
Jun. 30, 2010 (KR) 10-2010-0063162

(51) Int. Cl. F16H 3/44; F16H 57/10

(52) U.S. Cl. 475/284; 475/271

(57) ABSTRACT

Various aspects of the present invention are directed to provide a gear train of an automatic transmission for vehicles having advantages of simplifying structures of the automatic transmission and improving power delivery performance and fuel economy as a consequence of realizing at least eight forward speeds and one reverse speed by combining two simple planetary gear sets and a double sun gear planetary gear set having two sun gears and a center member disposed between the sun gears and connected to a planet carrier with four clutches and two brakes.

### CROSS-REFERENCE TO RELATED APPLICATION

The present application claims priority to Korean Patent Application No. 10-2010-0063162 filed in the Korean Intellectual Property Office on Jun. 30, 2010, the entire contents of which is incorporated herein for all purposes by this reference.

### BACKGROUND OF THE INVENTION

1. Field of the Invention

The present invention relates to a gear train of an automatic transmission for vehicles which realizes at least eight forward speeds and one reverse speed by combining two simple planetary gear sets and a double sun gear planetary gear set having two sun gears and a center member disposed between the sun gears and connected to a planet carrier with four clutches and two brakes.

2. Description of Related Art

A typical shift mechanism of an automatic transmission utilizes a combination of a plurality of planetary gear sets. A gear train of such an automatic transmission that includes the plurality of planetary gear sets changes rotational speed and torque received from a torque converter of the automatic transmission, and accordingly transmits the changed torque to an output shaft.

It is well known that when a transmission realizes a greater number of shift speeds, speed ratios of the transmission can be more optimally designed, and therefore a vehicle can have economical fuel mileage and better performance. For that reason, an automatic transmission that is able to realize more shift speeds is under continuous investigation.

In addition, with the same number of speeds, features of a gear train, such as durability, efficiency in power transmission, and size, substantially depend on the layout of the combined planetary gear sets. Therefore, designs for a combining structure of a gear train are also under continuous investigation.

A manual transmission that has too many speeds causes inconvenience to a driver. Therefore, the advantageous features of having more shift-speeds are more important in an automatic transmission because an automatic transmission automatically controls the shifting operations.

Currently, four-speed and five-speed automatic transmissions are most often found on the market. However, six-speed automatic transmissions have also been realized for enhancement of performance of power transmission and for enhanced fuel mileage of a vehicle. In addition, seven-speed automatic transmissions and eight-speed automatic transmissions have been developed at a good pace.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a gear train of an automatic transmission for vehicles having advantages of simplifying structures of the automatic transmission and improving power delivery performance and fuel economy as a consequence of realizing at least eight forward speeds and one reverse speed by combining two simple planetary gear sets and a double sun gear planetary gear set having two sun gears and a center member disposed between the sun gears and connected to a planet carrier with four clutches and two brakes.

In an aspect of the present invention, the gear train of an automatic transmission for vehicles may achieve eight forward speeds and one reverse speed by combining first, second, and third planetary gear sets with friction members including four clutches and two brakes, wherein the first planetary gear set may include a first rotation element always operated as a fixed element, a second rotation element always outputting a reduced rotation speed, and a third rotation element connected to an input shaft and operated as an input element, wherein the second and third planetary gear sets may be connected by first and second connecting members so as to be operated as a compound planetary gear set having four rotation elements, wherein the third planetary gear set may be a double sun gear planetary gear set provided with two sun gears and a center member disposed between the two sun gears and connected to a third planet carrier, and wherein the second and third planetary gear sets may include a fourth rotation element selectively connected to the input shaft and the second rotation element and selectively operated as a fixed element, a fifth rotation element selectively connected to the input shaft and selectively operated as a fixed element, a sixth rotation element connected to an output gear and always operated as an output element, and a seventh rotation element selectively connected to the second rotation element.

The first planetary gear set may be a double pinion planetary gear set having a first sun gear, a first planet carrier, and a first ring gear as rotation elements thereof, the second planetary gear set may be a single pinion planetary gear set having a second sun gear, a second planet carrier, and a second ring gear as rotation elements thereof, and the third planetary gear set may be the double sun gear planetary gear set having third and fourth sun gears, a third planet carrier, and a third ring gear as rotation elements thereof.

The first connecting member directly connects the second sun gear with the third sun gear, and the second connecting member directly connects the second carrier and the third ring gear.

The first rotation element may be the first sun gear, the second rotation element may be the first ring gear, the third rotation element may be the first planet carrier, the fourth rotation element may be the second, third, and fourth sun gears, the fifth rotation element may be the third planet carrier, the sixth rotation element may be the second planet carrier and the third ring gear, and the seventh rotation element may be the second ring gear.

The friction members may include a first clutch selectively connecting the first ring gear with the second ring gear, a second clutch selectively connecting the first ring gear with the second sun gear, a third clutch selectively connecting the input shaft with the center member, a fourth clutch selectively connecting the input shaft with the second sun gear, a first brake selectively connecting the fourth sun gear with a transmission housing, and a second brake selectively connecting the third planet carrier with the transmission housing.

The first clutch and the second brake may be operated at a first forward speed, the first clutch and the first brake may be operated at a second forward speed, the first and second clutches may be operated at a third forward speed, the first and fourth clutches may be operated at a fourth forward speed, the first and third clutches may be operated at a fifth forward speed, the third and fourth clutches may be operated at a sixth forward speed, the second and third clutches may be operated at a seventh forward speed, the third clutch and the first brake may be operated at an eighth forward speed, and the second clutch and the second brake may be operated at a reverse speed.

In another aspect of the present invention, the gear train of an automatic transmission for vehicles may include a first planetary gear set being a double pinion planetary gear set, and having a first sun gear, a first planet carrier, and a first ring gear, a second planetary gear set being a single pinion planetary gear set, and having a second sun gear, a second planet carrier, and a second ring gear, a third planetary gear set being a double sun gear planetary gear set, and having third and fourth sun gears, a third planet carrier, and a third ring gear, and four clutches and two brakes selectively combining the first, second, and third planetary gear sets, wherein an input shaft may be directly connected to the first planet carrier, the second and third sun gears may be directly connected to each other through a first connecting member, the second planet carrier and the third ring gear may be directly connected to each other, the first sun gear may be directly connected to a transmission housing, and the third ring gear may be directly connected to an output gear, and wherein a first clutch selectively connects the first ring gear with the second ring gear, a second clutch selectively connects the first ring gear with the second sun gear, a third clutch selectively connects a center member disposed between the third and fourth sun gears and connected to the third planet carrier with the input shaft, a fourth clutch selectively connects the input shaft with the second sun gear, a first brake selectively connects the fourth sun gear with the transmission housing, and a second brake selectively connects the third planet carrier with the transmission housing.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic diagram of a gear train according to an exemplary embodiment of the present invention.

FIG. 2 is a schematic diagram showing connections of rotation elements and friction members in a gear train according to an exemplary embodiment of the present invention.

FIG. 3 is an operational chart for a gear according to an exemplary embodiment of the present invention.

FIG. 4 is a lever diagram for a gear train according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Description of components that are not necessary for explaining the present invention will be omitted, and the same constituent elements are denoted by the same reference numerals in this specification.

In the detailed description, ordinal numbers are used for distinguishing constituent elements having the same terms, and have no specific meanings.

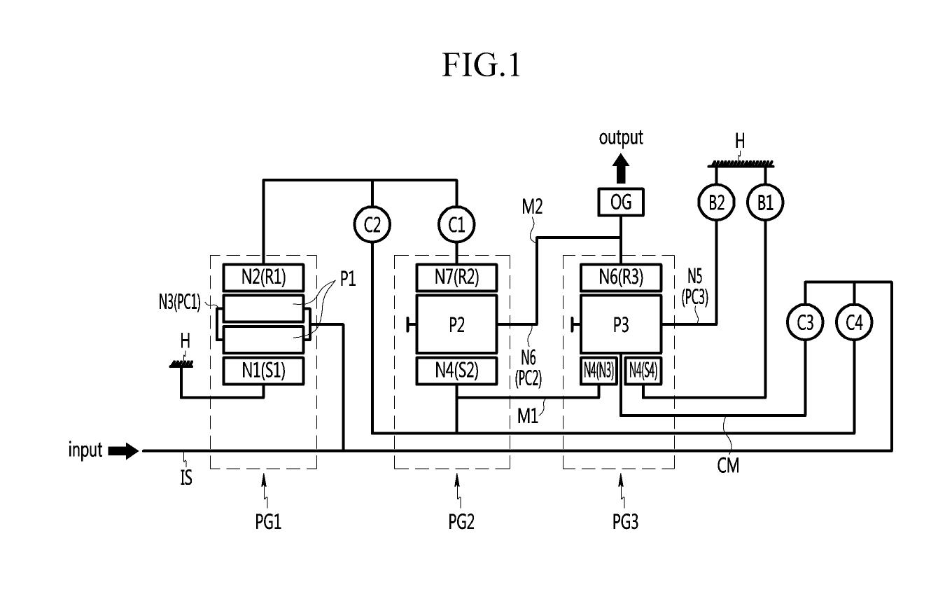

FIG. 1 is a schematic diagram of a gear train according to an exemplary embodiment of the present invention. PG1 represents a first planetary gear set, PG2 represents a second planetary gear set, PG3 represents a third planetary gear set, C1 represents a first clutch, C2 represents a second clutch, C3 represents a third clutch, C4 represents a fourth clutch, B1 represents a first brake, B2 represents a second brake, IS represents an input shaft forming an input member, and OG represents an output gear forming an output member in the drawings.

The first, second, and third planetary gear sets PG1, PG2, and PG3 are disposed on the same axis (input shaft). A rotation speed input from the input shaft IS is changed by the first, second, and third planetary gear sets PG1, PG2, and PG3 and is output through the output gear OG. The first planetary gear set PG1 is disposed close to an engine, and the second and third planetary gear sets PG2 and PG3 are sequentially disposed at the rear of the first planetary gear set PG1.

The input shaft IS is an input member and denotes a turbine shaft of a torque converter. Torque transmitted from a crankshaft of the engine is converted by the torque converter and is input to the gear train through the input shaft IS. The output shaft OS is an output member and is connected to a well-known differential apparatus so as to transmit an output of the gear train to driving wheels.

The first planetary gear set PG1 is a double pinion planetary gear set, and includes a first sun gear 51, a first ring gear R1, and a first planet carrier PC1 supporting a first pinion P1 engaged with both gears S1 and R1.

The second planetary gear set PG2 is a single pinion planetary gear set, and includes a second sun gear S2, a second ring gear R2, and a second planet carrier PC2 supporting a second pinion P2 engaged with both gears S2 and R2.

The third planetary gear set PG3 is a double sun gear planetary gear set, and includes a third sun gear S3 and a fourth sun gear S4, a third pinion P3 engaged with the third and the fourth sun gears S3 and S4, a third planet carrier PC3 supporting the third pinion P3, a center member CM disposed between the third and fourth sun gears S3 and S4 and connected to the third planet carrier PC3, and a third ring gear R3 engaged with the third pinion P3.

The center member CM is coupled to the third planet carrier PC3 and rotates integrally with the third planet carrier PC3.

In addition, the second planetary gear set PG2 and the third planetary gear set PG3 are connected to each other by first and second connecting members M1 and M2. The first connecting member M1 connects the second sun gear S2 with the third sun gear S3, and the second connecting member M2 connects the second planet carrier PC2 with the third ring gear R3 such that the second planetary gear set PG2 and the third planetary gear set PG3 are operated as one compound planetary gear set.

In addition, the first, second, and third planetary gear sets PG1, PG2, and PG3 are combined by four clutches C1, C2, C3, and C4 and two brakes B1 and B2.

The first planet carrier PC1 is directly connected to the input shaft IS so as to be always operated as an input element, the first sun gear 51 is connected to a transmission housing H so as to be always operated as a fixed element, and the second planet carrier PC2 and the third ring gear R3 are directly connected to the output gear OG so as to be always operated as an output element.

In addition, the first clutch C1 selectively connects the first ring gear R1 with the second ring gear R2, the second clutch C2 selectively connects the first ring gear R1 with the second sun gear S2, the third clutch C3 selectively connects the input shaft IS with the center member CM, and the fourth clutch C4 selectively connects the input shaft IS with the second sun gear S2.

In addition, the first brake B1 selectively connects the fourth sun gear S4 with the transmission housing H, and the second brake B2 selectively connects the third planet carrier PC3 with the transmission housing H.

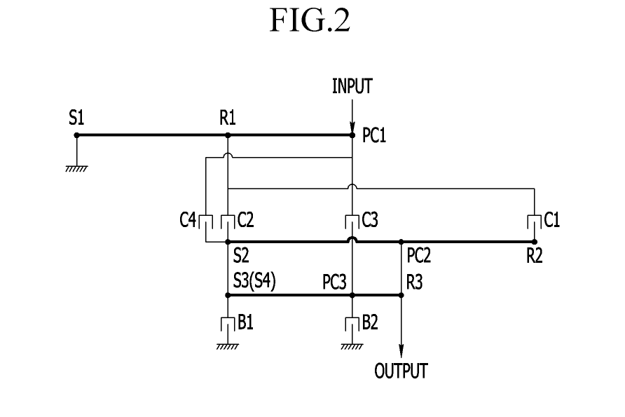

Connections of the rotation elements and the friction members may be well understood referring to FIG. 2.

Meanwhile, the first and second clutches C1 and C2 are disposed at an external circumference of the second planetary gear set PG2, the first and second brakes B1 and B2 are disposed at the rear of the third planetary gear set PG3, and the third and fourth clutches C3 and C4 are disposed at the rear of the first and second brakes B1 and B2.

If the friction elements are dispersed as described above, formation of hydraulic lines for supplying hydraulic pressure to such friction elements may be simplified, and weight balance in the automatic transmission may be enhanced.

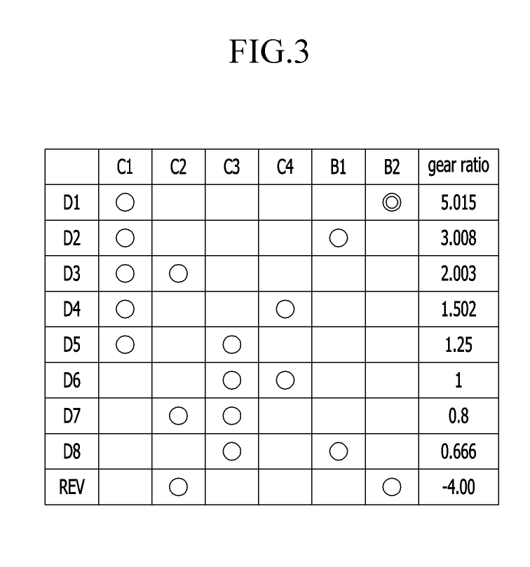

FIG. 3 is an operational chart for a gear train according to an exemplary embodiment of the present invention. That is, FIG. 3 shows which clutches and brakes are operated at each shift-speed. As shown in FIG. 3, two friction members are operated at each shift-speed according to an exemplary embodiment of the present invention.

That is, the first clutch C1 and the second brake B2 are operated at a first forward speed D1, the first clutch C1 and the first brake B1 are operated at a second forward speed D2, the first and second clutches C1 and C2 are operated at a third forward speed D3, the first and fourth clutches C1 and C4 are operated at a fourth forward speed D4, the first and third clutches C1 and C3 are operated at a fifth forward speed D5, the third and fourth clutches C3 and C4 are operated at a sixth forward speed D6, the second and third clutches C2 and C3 are operated at a seventh forward speed D7, the third clutch C3 and the first brake B1 are operated at an eighth forward speed D8, and the second clutch C2 and the second brake B2 are operated at a reverse speed REV.

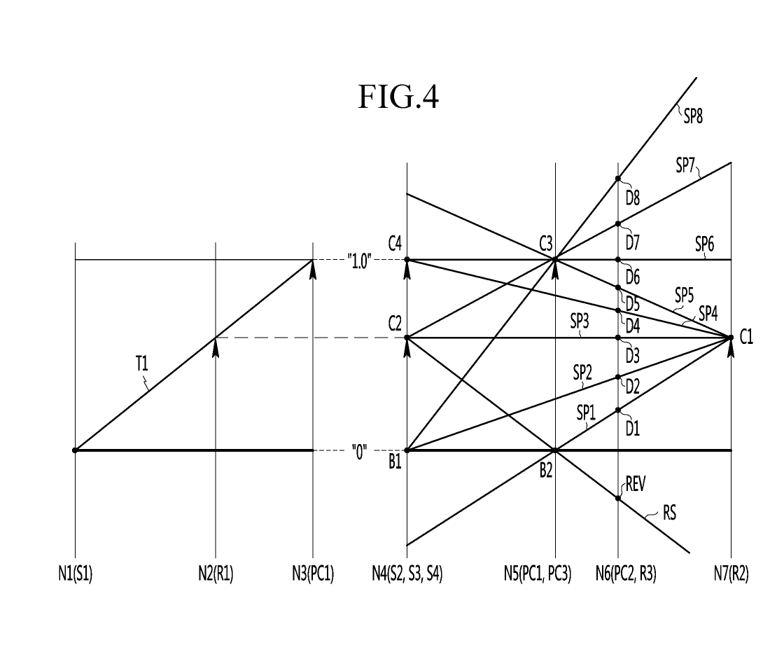

FIG. 4 is a lever diagram for a gear train according to an exemplary embodiment of the present invention. In the drawings, a lower horizontal line represents a rotational speed is “0”, and an upper horizontal line represents a rotational speed is “1.0”, that is, the rotational speed thereof is the same as that of the input shaft IS.

Three vertical lines of the first planetary gear set PG1 sequentially represent the first sun gear S1 being a first rotation element N1, the first ring gear R1 being a second rotation element N2, and the first planet carrier PC1 being a third rotation element N3 from the left to the right, and distances therebetween are set according to a gear ratio (teeth number of the sun gear/teeth number of the ring gear) of the first planetary gear set PG1.

Four vertical lines of the second and third planetary gear sets PG2 and PG3 sequentially represent the second, third, and fourth sun gears S2, S3, and S4 being a fourth rotation element N4, the third planet carrier PC3 being a fifth rotation element N5, the second planet carrier PC2 and the third ring gear R3 being a sixth rotation element N6, the second ring gear R2 being a seventh rotation element N7, and distances therebetween are set according to gear ratios (teeth number of the sun gear/teeth number of the ring gear) of the second and third planetary gear sets PG2 and PG3.

Position of each rotation element in the lever diagram is well known to a person of an ordinary skill in the art who designs a gear train, and thus detailed description will be omitted.

[First Forward Speed]

As shown in FIG. 3, the first clutch C1 and the second brake B2 are operated at the first forward speed D1.

Accordingly, in a state that a rotation speed of the input shaft IS is input to the third rotation element N3, the first rotation element N1 is operated as the fixed element. Therefore, the rotation elements of the first planetary gear set PG1 forms a first shift line T1 and the reduced rotation speed is output through the second rotation element N2.

In a state that the reduced rotation speed is delivered to the second planetary gear set PG2 through the seventh rotation element N7 by an operation of the first clutch C1, the fifth rotation element N5 is operated as the fixed element by an operation of the second brake B2. Therefore, a first shift line SP1 is formed as shown in FIG. 4. Therefore, the first shift line SP1 crosses the vertical line of the sixth rotation element N6 that is the output element and the first forward speed D1 is output.

[Second Forward Speed]

The second brake B2 which was operated at the first forward speed D1 is released and the first brake B1 is operated at the second forward speed D2.

In a state that the reduced rotation speed is input to the seventh rotation element N7 such as the first forward speed D1, the fourth rotation element N4 is operated as the fixed element by an operation of the first brake B1. Therefore, a second shift line SP2 is formed as shown in FIG. 4. Therefore, the second shift line SP2 crosses the vertical line of the sixth rotation element N6 that is the output element and the second forward speed D2 is output.

[Third Forward Speed]

As shown in FIG. 3, the first brake B1 that was operated at the second forward speed D2 is released and the second clutch C2 is operated at the third forward speed D3.

In a state that the reduced rotation speed is input to the seventh rotation element N7 such as the second forward speed D2, the reduced rotation speed is also input to the fourth rotation element N4 by an operation of the second clutch C2. As shown in FIG. 4, the second and third planetary gear sets PG2 and PG3 become direct-coupling state and a third shift line SP3 is formed. Therefore, the third shift line SP3 crosses the vertical line of the sixth rotation element N6 that is the output element and the third forward speed D3 is output.

[Fourth Forward Speed]

As shown in FIG. 3, the second clutch C2 that was operated at the third forward speed D3 is released and the fourth clutch C4 is operated at the fourth forward speed D4.

In a state that the reduced rotation speed is input to the seventh rotation element N7 such as the third forward speed D3, a rotation speed of the third rotation element N3 (the same as that of the input shaft) is input to the fourth rotation element N4 by an operation of the fourth clutch C4. As shown in FIG. 4, a fourth shift line SP4 is formed. Therefore, the fourth shift line SP4 crosses the vertical line of the sixth rotation element N6 that is the output element and the fourth forward speed D4 is output.

[Fifth Forward Speed]

As shown in FIG. 3, the fourth clutch C4 that was operated at the fourth forward speed D4 is released and the third clutch C3 is operated at the fifth forward speed D5.

In a state that the reduced rotation speed is input to the seventh rotation element N7 such as the fourth forward speed D4, the rotation speed of the input shaft IS is input to the third planet carrier PC3 forming the fifth rotation element N5 through the center member CM by an operation of the third clutch C3. As shown in FIG. 4, a fifth shift line SP5 is formed. Therefore, the fifth shift line SP5 crosses the vertical line of the sixth rotation element N6 that is the output element and the fifth forward speed D5 is output.

[Sixth Forward Speed]

As shown in FIG. 3, the first clutch C1 that was operated at the fifth forward speed D5 is released and the fourth clutch C4 is operated at the sixth forward speed D6.

In a state that the rotation speed of the input shaft IS is input respectively to the fifth and fourth rotation elements N5 and N4 by the operations of the third and fourth clutches C3 and C4. As shown in FIG. 4, the second and third planetary gear sets PG2 and PG3 become the direct-coupling state and a sixth shift line SP6 is formed. Therefore, the sixth shift line SP6 crosses the vertical line of the sixth rotation element N6 that is the output element and the sixth forward speed D6 is output.

[Seventh Forward Speed]

As shown in FIG. 3, the fourth clutch C4 that was operated at the sixth forward speed D6 is released and the second clutch C2 is operated at the seventh forward speed D7.

In a state that the rotation speed of the input shaft IS is input to the fifth rotation element N5 by the operation of the third clutch C3, the rotation speed of the second rotation element N2 is input to the fourth rotation element N4 by the operation of the second clutch C2. As shown in FIG. 4, a seventh shift line SP7 is formed. Therefore, the seventh shift line SP7 crosses the vertical line of the sixth rotation element N6 that is the output element and the seventh forward speed D7 is output.

[Eighth Forward Speed]

As shown in FIG. 3, the second clutch C2 that was operated at the seventh forward speed D7 is released and the first brake B1 is operated at the eighth forward speed D8.

In a state that the rotation speed of the input shaft IS is input to the fifth rotation element N5 such as the seventh forward speed D7, the fourth rotation element N4 is operated as the fixed element by the operation of the first brake B1. As shown in FIG. 4, an eighth shift line SP8 is formed. Therefore, the eighth shift line SP8 crosses the vertical line of the sixth rotation element N6 that is the output element and the eighth forward speed D8 is output.

[Reverse Speed]

As shown in FIG. 3, the second clutch C2 and the second brake B2 are operated at the reverse speed REV.

In a state that the rotation speed of the second rotation element N2 is input to the fourth rotation element N4 by the operation of the second clutch C2, the fifth rotation element N5 is operated as the fixed element by the operation of the second brake B2. As shown in FIG. 4, a reverse shift line RS is formed. Therefore, the reverse shift line RS crosses the vertical line of the sixth rotation element N6 that is the output element and the reverse speed REV is output.

As described above, eight forward speeds and one reverse speed are achieved by combining two simple planetary gear sets and a double sun gear planetary gear set having two sun gears and a center member disposed between the sun gears and connected to a planet carrier with four clutches and two brakes with four clutches and two brakes. Therefore, power delivery performance and fuel economy may be improved, and particularly, performance in reverse speeds may be improved according to an exemplary embodiment of the present invention

Since the frictional members are dispersedly disposed, formation of hydraulic lines may be simplified, weight balance in an automatic transmission may be enhanced.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A gear train of an automatic transmission for vehicles which achieves eight forward speeds and one reverse speed by combining first, second, and third planetary gear sets with friction members including four clutches and two brakes,
wherein the first planetary gear set comprises a first rotation element always operated as a fixed element, a second rotation element always outputting a reduced rotation speed, and a third rotation element connected to an input shaft and operated as an input element,
wherein the second and third planetary gear sets are connected by first and second connecting members so as to be operated as a compound planetary gear set having four rotation elements,
wherein the third planetary gear set is a double sun gear planetary gear set provided with two sun gears and a center member disposed between the two sun gears and connected to a third planet carrier, and
wherein the second and third planetary gear sets comprises a fourth rotation element selectively connected to the input shaft and the second rotation element and selectively operated as a fixed element, a fifth rotation element selectively connected to the input shaft and selectively operated as a fixed element, a sixth rotation element connected to an output gear and always operated as an output element, and a seventh rotation element selectively connected to the second rotation element.

2. The gear train of claim 1, wherein the first planetary gear set is a double pinion planetary gear set having a first sun gear, a first planet carrier, and a first ring gear as rotation elements thereof, the second planetary gear set is a single pinion planetary gear set having a second sun gear, a second planet carrier, and a second ring gear as rotation elements thereof, and the third planetary gear set is the double sun gear planetary gear set having third and fourth sun gears, a third planet carrier, and a third ring gear as rotation elements thereof.

3. The gear train of claim 2, wherein the first connecting member directly connects the second sun gear with the third sun gear, and the second connecting member directly connects the second carrier and the third ring gear.

4. The gear train of claim 2, wherein the first rotation element is the first sun gear, the second rotation element is the first ring gear, the third rotation element is the first planet carrier, the fourth rotation element is the second, third, and fourth sun gears, the fifth rotation element is the third planet carrier, the sixth rotation element is the second planet carrier and the third ring gear, and the seventh rotation element is the second ring gear.

5. The gear train of claim 3, wherein the friction members comprises:
a first clutch selectively connecting the first ring gear with the second ring gear;
a second clutch selectively connecting the first ring gear with the second sun gear;
a third clutch selectively connecting the input shaft with the center member;
a fourth clutch selectively connecting the input shaft with the second sun gear;
a first brake selectively connecting the fourth sun gear with a transmission housing; and
a second brake selectively connecting the third planet carrier with the transmission housing.

6. The gear train of claim 5, wherein the first clutch and the second brake are operated at a first forward speed,
the first clutch and the first brake are operated at a second forward speed,
the first and second clutches are operated at a third forward speed,
the first and fourth clutches are operated at a fourth forward speed,
the first and third clutches are operated at a fifth forward speed,
the third and fourth clutches are operated at a sixth forward speed,
the second and third clutches are operated at a seventh forward speed,
the third clutch and the first brake are operated at an eighth forward speed, and
the second clutch and the second brake are operated at a reverse speed.

7. A gear train of an automatic transmission for vehicles comprising:
a first planetary gear set being a double pinion planetary gear set, and having a first sun gear, a first planet carrier, and a first ring gear;
a second planetary gear set being a single pinion planetary gear set, and having a second sun gear, a second planet carrier, and a second ring gear;
a third planetary gear set being a double sun gear planetary gear set, and having third and fourth sun gears, a third planet carrier, and a third ring gear; and
four clutches and two brakes selectively combining the first, second, and third planetary gear sets,
wherein an input shaft is directly connected to the first planet carrier, the second and third sun gears are directly connected to each other through a first connecting member, the second planet carrier and the third ring gear are directly connected to each other, the first sun gear is directly connected to a transmission housing, and the third ring gear is directly connected to an output gear, and
wherein a first clutch selectively connects the first ring gear with the second ring gear, a second clutch selectively connects the first ring gear with the second sun gear, a third clutch selectively connects a center member disposed between the third and fourth sun gears and connected to the third planet carrier with the input shaft, a fourth clutch selectively connects the input shaft with the second sun gear, a first brake selectively connects the fourth sun gear with the transmission housing, and a second brake selectively connects the third planet carrier with the transmission housing.
